(19) United States
(12) Patent Application Publication
(10) Pub. No.: US 2018/0234463 A1
(43) Pub. Date: Aug. 16, 2018

(54) AUTONOMOUS SECURITY POLICY DECISION AND IMPLEMENTATION ACROSS HETEROGENEOUS IT ENVIRONMENTS

(71) Applicant: International Business Machines Corporation, Armonk, NY (US)

(72) Inventors: Caio E. Briski, Vinhedo (BR); Rodrigo A. Cremasco, Campinas (BR); Sergio Augusto S. Danin, Campinas (BR); Daniel K. Lima, Hortolandia (BR); Luiz G. Nascimento, Campinas (BR); Marcos V.I. Paraiso, Campinas (BR); Klalter de Abreu Santo, Sumare (BR); Emannuel Silva, Sumare (BR)

(21) Appl. No.: 15/433,098

(22) Filed: Feb. 15, 2017

(51) Int. Cl. H04L 29/06

(52) U.S. Cl. CPC H04L 63/205; H04L 63/1441

(57) ABSTRACT

The disclosure is directed to an autonomous method for dynamically providing a security policy. A method in accordance with an embodiment includes: determining an existence of a new Internet-based security threat; proposing a security threat update to an existing security policy in response to the existence of the new Internet-based security threat; determining a change in a set of business rules; proposing a business rules update to the existing security policy in response to the change in the set of business rules; combining the security threat update and the business rules update into a consolidated security policy update; and updating the existing security policy based on the consolidated security update.

### TECHNICAL FIELD

The present invention relates generally to information technology (IT) security, and more particularly, to a method and system for autonomous security policy decision and implementation across heterogeneous IT environments.

### RELATED ART

In today's IT industry, a myriad of technologies and architectures may be used to host applications for managing a company's core business processes. These may range from traditional client x server application solutions hosted on physical server environments, to distributed applications hosted on hybrid cloud environments. Such IT environments are becoming increasingly complex as technology evolves. Even more daunting than managing different IT environments is keeping them secure. Several security aspects must be taken into account, from network security, to proper authentication methods, to keeping data access restricted to authorized usage, to having an audit-ready IT environment, etc.

Today, many security applications and products are capable of automating various activities for scanning scan IT environments, based on predefined and static security policies, and remediating any issues found. Usually, a policy template is used and customized, during a solution deployment, and is reviewed after some time, if at all. However, no solution available today focuses on one key aspect: the definition and management of dynamic security policies.

Static security policies, for example created by IT security teams, do not take into account the business aspects of a company. This can create security holes and generate unnecessary effort to maintain a secure and audit ready IT environment. There is a need, therefore, for a solution that can create and manage security policies dynamically, making the IT security management process more effective and aligned to business needs.

Several security aspects should be taken into account when considering IT security as a whole, but one in particular is the need to manage effective security policies, which are used to set the definitions of many types of IT resources. Security policies define, for example, parameters, configurations, and expected values of operating systems, databases, middleware, mail servers, backup servers, network appliances, and/or the like, making sure each resource type is properly secure. Once a security policy is defined, there is a need to scan the resources, compare the scanned values against the defined policy and, when issues are found, to document, track, and remediate the issues.

As stated above, today's industry standard for managing IT security policy is static and performed manually. Usually, there is a set of standard security policies, which are tailored for a company's needs and deployed during an implementation phase. Then, after a predefined time interval (6 months, 12 months, 18 months, etc.) there is a review process to identify whether the deployed security policies are still valid, or if any update/change is needed. If any update/change is needed, the security policies are manually updated (e.g., in the tool used to execute the security policies). The current standard also does not take into account the business needs of the company and does not react quickly to potential high security exposures.

### SUMMARY

A first aspect of the invention provides an autonomous method for dynamically providing a security policy, including: determining an existence of a new Internet-based security threat; proposing a security threat update to an existing security policy in response to the existence of the new Internet-based security threat; determining a change in a set of business rules; proposing a business rules update to the existing security policy in response to the change in the set of business rules; combining the security threat update and the business rules update into a consolidated security policy update; and updating the existing security policy based on the consolidated security update.

A second aspect of the invention provides an autonomous system for dynamically providing a security policy, including: an autonomous security policy engine configured to: determine an existence of a new Internet-based security threat; propose a security threat update to an existing security policy in response to the existence of the new Internet-based security threat; determine a change in a set of business rules; propose a business rules update to the existing security policy in response to the change in the set of business rules; combine the security threat update and the business rules update into a consolidated security policy update; and update the existing security policy based on the consolidated security update.

A third aspect of the invention provides a computer program product comprising program code embodied in at least one computer-readable storage medium, which when executed, enables a computer system to implement an autonomous method for dynamically providing a security policy, the method including: determining an existence of a new Internet-based security threat; proposing a security threat update to an existing security policy in response to the existence of the new Internet-based security threat; determining a change in a set of business rules; proposing a business rules update to the existing security policy in response to the change in the set of business rules; combining the security threat update and the business rules update into a consolidated security policy update; and updating the existing security policy based on the consolidated security update.

Other aspects of the invention provide methods, systems, program products, and methods of using and generating each, which include and/or implement some or all of the actions described herein. The illustrative aspects of the invention are designed to solve one or more of the problems herein described and/or one or more other problems not discussed.

### BRIEF DESCRIPTION OF THE DRAWINGS

These and other features of the disclosure will be more readily understood from the following detailed description taken in conjunction with the accompanying drawings that depict various aspects of the invention.

FIG. 1 depicts an autonomous security policy decision and implementation system according to embodiments.

FIGS. 2A and 2B depict a process employed by the autonomous security policy decision and implementation system of FIG. 1 according to embodiments.

FIG. 3 depicts an illustrative computing environment according to embodiments.

It is noted that the drawings may not be to scale. The drawings are intended to depict only typical aspects of the invention, and therefore should not be considered as limiting the scope of the invention. In the drawings, like numbering represents like elements between the drawings.

### DETAILED DESCRIPTION

The present invention relates generally to information technology (IT) security, and more particularly, to a method and system for autonomous security policy decision and implementation across heterogeneous IT environments.

According to embodiments, an autonomous security policy definition engine is provided for dynamically creating and managing security policies based on known risks, business needs, and other factors. Once a security policy is created or dynamically updated, it can be used by available security management products to scan the resources of an IT environment.

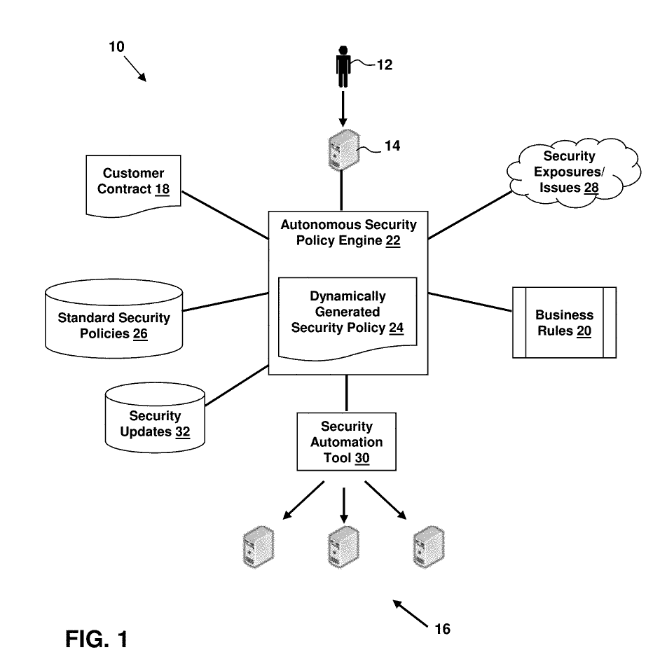

An autonomous security policy decision and implementation system 10 (hereafter “security system 10”) according to embodiments of the disclosure is depicted in FIG. 1.

A user 12 accesses the security system 10 via a security policy portal server 14. The security policy portal server 14 is configured to present consolidated reports (e.g., using a dashboard or other data presentation mechanism(s)) on security issues found on one or more different IT environments 16 (e.g., servers) managed by the security system 10. Through the security policy portal server 14, the user 12 may also define security exceptions, approve security policy updates proposed by the security system 10, input new security policies (either manually or by providing a document, such as a customer contract 18 and/or business rules 20, which can be used to generate policy rules), and/or perform other security-related tasks.

At the heart of the security system 10 is an autonomous security policy engine server 22. The autonomous security policy engine server 22 consumes and analyzes several types of data to determine what type of security policy should implemented and scanned on an IT environment 16. A method employed by the autonomous security policy engine server 22 for dynamically generating a security policy 24 is presented in detail below.

The data consumed and analyzed by the autonomous security policy engine server 22 may be obtained from a plurality of different sources. One such source includes one or more standard policies repositories 26, which store security policy templates and best practice data. The security policy templates and best practice data is usually composed of structured data (e.g., eXtensible Access Control Markup Language (XACML)). Another source of the data consumed and analyzed by the autonomous security policy engine server 22 includes a repository 28 containing data regarding Internet-based security exposures/issues (“security threats”). The security exposures/issues repositories 28 contain official documentation of identified security exposures/issues, typically published by various IT vendors, such as IBM, Microsoft, Redhat, Oracle, Apple, etc.

A document may be provided to the autonomous security policy engine server 22 in a non-structured data format (e.g., as a customer contract 18). Document conversion provided, for example, using IBM Bluemix-Watson services, may be used to parse the document. The parsed data can then be sent to a natural language classifier to identify key components of the document that can be used to create business rules to be considered during the definition of a security policy by the autonomous security policy engine server 22.

A security automation tool 30 receives/obtains a dynamically generated security policy 24 from the autonomous security policy engine 22. The security automation tool 30 implements the dynamically generated security policy 24 and executes corresponding scans on an IT environment 16. Examples of security automation tools 30 include IBM BigFix and Symantec Endpoint Protection, etc. Any security automation tool 30 capable of implementing a dynamically generated security policy 24 and executing scans based thereon may be used.

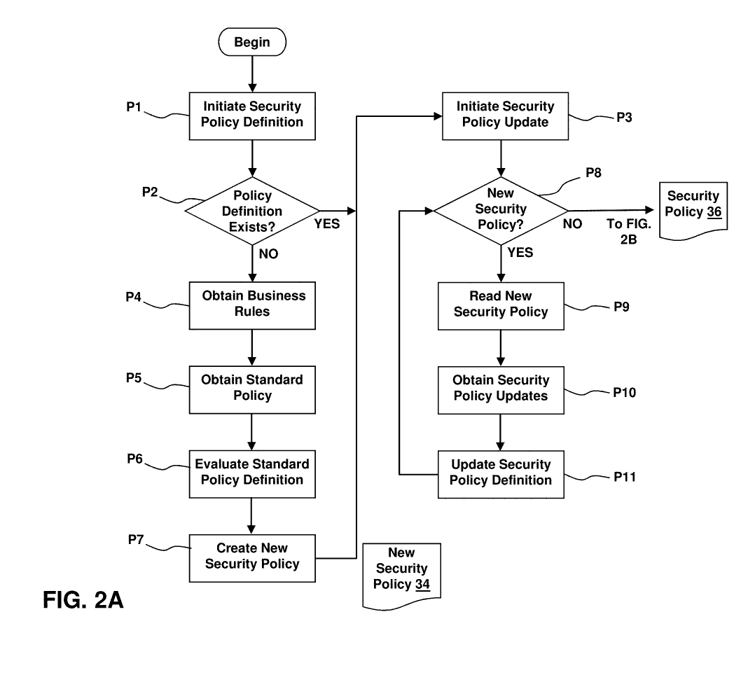

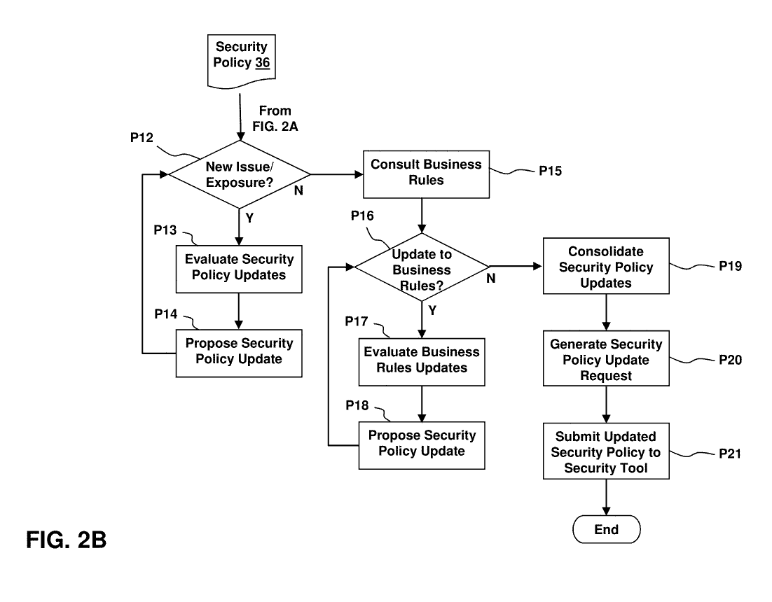

FIGS. 2A and 2B depict a process employed by the autonomous security policy engine server 22 of FIG. 1 according to embodiments.

At P1, a security policy definition process is initiated by a user 12 for an IT environment 16 via the security policy portal server 14. At P2, a determination is made regarding the existence of a security policy definition for the IT environment 16. If a security policy definition exists (YES, P2), flow passes to P3. If a security policy definition does not exist (NO, P2), flow passes to P4, where a process for creating an initial security policy definition is initiated.

The process for creating an initial security policy definition is initiated at P4, where business rules 20 associated with the IT environment 16 are obtained and evaluated. At P5, a standard policy is selected from a standard policy repository 26 based on the evaluation (e.g., the standard security policy providing a best fit to the business rules 20 is selected) and, at P6, the definition of the selected standard policy is evaluated and edited as necessary (e.g., in accordance with the business rules 20) to create a new security policy 34. Flow then passes to P3. Other suitable techniques may also be used to create a new security policy.

In response to an existing security policy (YES, P2), or after creation of a new security policy (P4-P7), a security policy update process is initiated at P3, which flows to P8. Initially, it is determined at P8 whether a new security policy 34 has been created. If so (YES, P8), flow passes to P9. If a security policy 36 already exists (NO, P8), flow passes to P12.

At P9, the new security policy 34 is read. At P10, the new security policy 34 is evaluated to determine if it needs to be updated to address any relevant Internet-based security exposures/issues stored in the repository 28. Based on the evaluation performed at P10, one or more security policy updates that address the relevant Internet-based security exposures/issues are generated (and stored in a repository 32) and/or obtained (e.g., from the repository 32 or other source of security updates). The definition of the new security policy 34 is then updated (e.g., automatically) using the security policy update(s) to address the relevant Internet-based security exposures/issues. Flow then passes to P12 via P8.

At P12, a determination is made regarding the existence of a new Internet-based security exposure/issue. This may include, for example, automatically (continuously or periodically) consulting the repository 28 for the existence of a new Internet-based security exposure/issue and obtaining information regarding the new Internet-based security exposure/issue from the repository 28 or other source. In some cases, a notification regarding an Internet-based security exposure/issue newly added to the repository 28 may be automatically provided to the autonomous security policy engine server 22 (e.g., by an IT vendor, pushed by the repository 28, etc.). In response to such a notification, the autonomous security policy engine server 22 can consult the corresponding repository 28 or other source for information regarding the new Internet-based security exposure/issue. Regardless, if a new Internet-based security exposure/issue exists (YES, P12), flow immediately passes to P13. If a new Internet-based security exposure/issue does not exist (NO, P12), flow passes to P15.

At P13, available security policy updates (e.g., stored in repository 32) are evaluated and a security policy update capable of addressing the new Internet-based security exposure/issue is obtained, either by selecting an existing security policy update (e.g., stored in repository 32) or by generating the necessary security policy update. At P14, a security policy update is proposed to address the new Internet-based security exposure/issue. Flow then passes back to P12. If another new Internet-based security exposure/issue is determined to exist (YES, P12), flow again immediately passes to P13, otherwise, if there are no other new Internet-based security exposures/issues (NO, P12), flow passes to P15.

At P15, the business rules 20 are consulted. At P16, the business rules 20 are examined (continuously or periodically) to determine if any of the business rules 20 have been updated. If it is determined that a business rule 20 has been updated (YES, P16), flow immediately passes to P17. If it is determined that a business rule 20 has not been updated (NO, P16), flow passes to P19.

In response to a determination that a business rule 20 has been updated (YES, P16), the updated business rule 20 is evaluated at P17 to determine the effect of the updated business rule 20 on the security policy 36. At P18, based on the evaluation carried out in P17, a security policy update is proposed to address the updated business rule 20. The proposed security policy update may be obtained either by selecting an existing security policy update or by generating the necessary security policy update. Flow then passes back to P16. If there is another updated business rule 20 (YES, P16), flow again immediately passes to P17, otherwise flow passes to P19.

To evaluate business rules 20, such as what is the difference between production and development environments, when should the environment be more reliable or less reliable (e.g., e-commerce during black Friday), etc., a policy based solution, stored on a database, may be used. Such a solution will propose the adoption of a set, or subset, of security policies defined in the standard policies repository 26. An autonomous cognitive approach may also be used, based on services such as IBM Bluemix Watson Retrieve and Rank combined with Concept Insights, that will be able to understand business related events and evaluate which security policy, from the standard security policies repository, should be used.

At P19, all of the generated security policy updates (e.g., output at P14 for new Internet-based security exposures/issues and output at P18 for updates to the business rules 20) are consolidated and, at P20, a security policy update request is generated based on the consolidated security policy updates. If the security policy update request is approved (e.g., by a user 12 via the security policy portal server 14) and is technically feasible (e.g., evaluated and approved by technical support), the definitions of the security policy 36 are updated to provide a dynamically generated security policy 24. The dynamically generated security policy 24 is subsequently submitted at P21 to the security automation tool 30, which implements the dynamically generated security policy 24 and executes corresponding scans on the IT environment 16. In other cases, the consolidated security policy updates may be provided to the security automation tool 30, which may also be capable of updating the security policy 36 to provide a dynamically generated security policy 24.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While it is understood that the program product of the present invention may be manually loaded directly in a computer system via a storage medium such as a CD, DVD, etc., the program product may also be automatically or semi-automatically deployed into a computer system by sending the program product to a central server or a group of central servers. The program product may then be downloaded into client computers that will execute the program product. Alternatively the program product may be sent directly to a client system via e-mail. The program product may then either be detached to a directory or loaded into a directory by a button on the e-mail that executes a program that detaches the program product into a directory. Another alternative is to send the program product directly to a directory on a client computer hard drive.

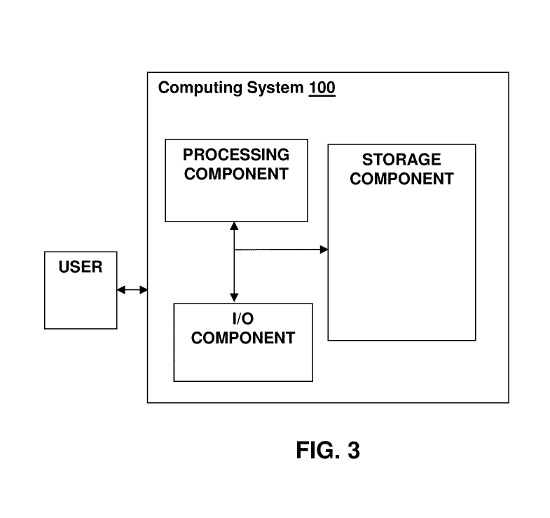

FIG. 3 depicts an illustrative computing system 100 for implementing the present invention, according to embodiments. The computing system 100 may comprise any type of computing device and, and for example includes at least one processor, memory, an input/output (I/O) (e.g., one or more I/O interfaces and/or devices), and a communications pathway. In general, processor(s) execute program code, such as the autonomous security policy decision and implementation system 10, which is at least partially fixed in memory. While executing program code, processor(s) can process data, which can result in reading and/or writing transformed data from/to memory and/or I/O for further processing. The pathway provides a communications link between each of the components in computing system 100. I/O can comprise one or more human I/O devices, which enable a user to interact with computing system 100.

The various embodiments discussed herein can offer several technical and commercial advantages, some of which are discussed herein by way of example. Embodiments of the present disclosure can eliminate the deficiencies suffered by the reactive network bandwidth balancing techniques employed by the prior art. Furthermore, embodiments of the method discussed herein can be used to automatically balance network bandwidth to minimize the over/under subscribing of network resources.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual skilled in the art are included within the scope of the invention as defined by the accompanying claims.

What is claimed is:

1. An autonomous method for dynamically providing a security policy, comprising:
determining an existence of a new Internet-based security threat;
proposing a security threat update to an existing security policy in response to the existence of the new Internet-based security threat;
determining a change in a set of business rules;
proposing a business rules update to the existing security policy in response to the change in the set of business rules;
combining the security threat update and the business rules update into a consolidated security policy update; and
updating the existing security policy based on the consolidated security update.

2. The autonomous method for dynamically providing a security policy according to claim 1, further comprising:
determining an existence of at least one additional new Internet-based security threat;
proposing an additional security threat update to the existing security policy in response to the existence of each additional new Internet-based security threat; and
including each additional security threat update in the consolidated security policy update.

3. The autonomous method for dynamically providing a security policy according to claim 1, wherein the proposing the security threat update occurs immediately after the determination of the new Internet-based security threat.

4. The autonomous method for dynamically providing a security policy according to claim 1, further comprising:
determining an existence of at least one additional change in the set of business rules;
proposing an additional business rules update to the existing security policy in response to the existence of each additional change business rules update; and
including each additional business rules update in the consolidated security policy update.

5. The autonomous method for dynamically providing a security policy according to claim 1, wherein the proposing the business rules update occurs immediately after the determination of the change in the set of business rules.

6. The autonomous method for dynamically providing a security policy according to claim 1, wherein the determining the new Internet-based security threat further comprises continuously monitoring at least one repository containing security exposures and security issues.

7. The autonomous method for dynamically providing a security policy according to claim 1, wherein the determining the new Internet-based security threat further comprises continuously monitoring the set of business rules for any changes.

8. The autonomous method for dynamically providing a security policy according to claim 1, further comprising:
implementing the updated security policy in a security automation tool; and
scanning, using the security automation tool, at least one resource of an IT environment using the updated security policy.

9. An autonomous system for dynamically providing a security policy, comprising:
an autonomous security policy engine configured to:
determine an existence of a new Internet-based security threat;
propose a security threat update to an existing security policy in response to the existence of the new Internet-based security threat;
determine a change in a set of business rules;
propose a business rules update to the existing security policy in response to the change in the set of business rules;
combine the security threat update and the business rules update into a consolidated security policy update; and
update the existing security policy based on the consolidated security update.

10. The autonomous system for dynamically providing a security policy according to claim 9, further comprising a security automation tool for implementing the updated security policy and scanning at least one resource of an IT environment using the updated security policy.

11. The autonomous system for dynamically providing a security policy according to claim 9, further comprising at least one repository containing security exposures and security issues, wherein the autonomous security policy engine is configured to determine the new Internet-based security threat by continuously monitoring the at least one repository.

12. A computer program product comprising program code embodied in at least one computer-readable storage medium, which when executed, enables a computer system to implement an autonomous method for dynamically providing a security policy, the method comprising:
determining an existence of a new Internet-based security threat;
proposing a security threat update to an existing security policy in response to the existence of the new Internet-based security threat;
determining a change in a set of business rules; proposing a business rules update to the existing security policy in response to the change in the set of business rules;
combining the security threat update and the business rules update into a consolidated security policy update; and
updating the existing security policy based on the consolidated security update.

13. The computer program product according to claim 12, the method further comprising:
determining an existence of at least one additional new Internet-based security threat;
proposing an additional security threat update to the existing security policy in response to the existence of each additional new Internet-based security threat; and
including each additional security threat update in the consolidated security policy update.

14. The computer program product according to claim 12, wherein the proposing the security threat update occurs immediately after the determination of the new Internet-based security threat.

15. The computer program product according to claim 12, the method further comprising:
determining an existence of at least one additional change in the set of business rules;
proposing an additional business rules update to the existing security policy in response to the existence of each additional change business rules update; and
including each additional business rules update in the consolidated security policy update.

16. The computer program product according to claim 12, wherein the proposing the business rules update occurs immediately after the determination of the change in the set of business rules.

17. The computer program product according to claim 12, wherein the determining the new Internet-based security threat further comprises continuously monitoring at least one repository containing security exposures and security issues.

18. The computer program product according to claim 12, wherein the determining the new Internet-based security threat further comprises continuously monitoring the set of business rules for any changes.

19. The computer program product according to claim 12, further comprising:
implementing the updated security policy; and
scanning at least one resource of an IT environment using the updated security policy.
